(19) United States
(12) Patent Application Publication
(10) Pub. No.: US 2001/0012764 A1
(43) Pub. Date: Aug. 9, 2001

(54) FIXED WIRELESS ACCESS CHANNEL RADIO COMMUNICATION SYSTEM

(76) Inventors: KEITH RUSSELL EDWARDS, DEVON (GB); ALISTER GRAHAM BURR, YORK (GB); TIMOTHY CONRAD TOZER, YORK (GB); DAVID ANDREW JAMES PEARCE, YORK (GB)

Correspondence Address: LEE MANN SMITH, MCWILLIAMS, SWEENY &, OHLSON, P O BOX 2786, CHICAGO, IL, 606902786

(21) Appl. No.: 08/790,946

(22) Filed: Jan. 29, 1997

(30) Foreign Application Priority Data
Oct. 15, 1996 (GB) 9621465.5

(51) Int. Cl. H04M 1/00

(52) U.S. Cl. 455/69; 455/562

(57) ABSTRACT

Radio signals in a radio communications system may be modulated in a variety of fashions; there are a finite number of available individual communications channels for separate sets of parties to communicate with each other. The optimisiation of a transmitting antenna requires knowledge of the channel over which the signal is to be transmitted. A system operable over a channel having characteristics such that parameters of a transmission path can be predicted from received signals is disclosed; said system comprising means for analyzing signals received from said channel and a plurality of signal generation means adapted to vary output in response to said signal analysis.

### FIELD OF THE INVENTION

This invention relates to radio communications and in particular relates to an adaptive antenna system for a radio communications system.

### BACKGROUND TO THE INVENTION

In radio communications, signals are transmitted at a particular frequency or in a frequency band. The signals may be modulated in a 20 variety of fashions using techniques such as Time Division Multiple Access (TDMA), Frequency Division Multiple Access (FDMA), and a multitude of other techniques. Nevertheless there are a finite number of available individual communications channels for separate sets of parties to communicate with each other. For example in a TDMA system there are a number of time slots for data to be encoded as separate channels on a single bearer of a frequency band.

In many mobile radio communications systems such as GSM digital radio protocol, the communications channel hops from one frequency band to another according to a specified routine. This type of protocol overcomes the effects of fading, scattering and other transmission problems on a particular channel simply by swapping to an alternate channel. Such a system provides most users with a signal quality corresponding to the average signal quality of the system.

In both mobile and fixed radio systems, obstacles in a signal path, such as buildings in built-up areas and hills in rural areas, act as signal scatters. These scattered signals interact and their resultant signal at a receiving antenna may be subject to deep fading. Typically the signal envelope will follow a Rayleigh distribution over short distances, especially in heavily cluttered regions.

In fixed radio applications, changes in channel fading characteristics are typically slow compared with the transmission rate of the channel. Accordingly a good channel is likely to remain a good channel for a long period of time and vice versa a poor channel remains poor for a long period of time.

As the stations of the system, in fixed radio applications, are of fixed location, the fading problems will arise due to stationary obstacles in the signal path such as hills and surrounding houses or trees. Accordingly there is typically one set of users in a fixed system who on average see lower signal quality than other users of the system.

An adaptive system may employ antenna diversity where a plurality of antenna are used to receive transmitted signals. The system selects received signal from these receive antennas or combines their received signals in a way that improves the characteristics of the data signals output from the system.

However optimising a transmitting antenna requires knowledge of the channel over which the signal is to be transmitted. Previous attempts at obtaining this information have resulted in additional signalling overhead from inter alia measurement and modelling of the channel. This overhead can be sufficiently large to detract from the gains in system performance that are available from adaptive antenna and other adaptive transmission techniques.

### OBJECT OF THE INVENTION The present invention seeks to provide an improved form of adaptive signal transmission and reception without unduly increasing the signalling overhead of the system.

### SUMMARY OF THE INVENTION

According to a first aspect of the invention a radio communications system is provided. The system operating over a channel having characteristics such that parameters of a transmission path can be predicted from received signals; said system comprising means for analysing signals received from said channel and a plurality of signal generation means adapted to vary output in response to said signal analysis.

According to a second aspect of the present invention a method of communicating over a channel is provided. The channel having characteristics such that transmission path characteristics are predictable from signals received from said channel; said method comprising the steps of:

1) analysing signals received from said channel;

2) varying the output from a plurality of signal generation means in response to said signal analysis.

According to a third aspect of the present invention a signal transmitting and receiving station for use with a radio communications system is provided. The system operating over a channel with characteristics such that parameters of a transmission path can be predicted from received signals; said station further comprising a plurality of signal receiving and signal processing means adapted to analyse signals received from said channel and a plurality of signal generation means adapted to vary output in response to said signal analysis.

The above three aspects of the present invention allow signalling overhead in an adaptive antenna scheme to be reduced by utilising the properties of a channel where forward path characteristics can be determined from reverse path characteristics.

It is preferred that said plurality of signal generation means are adapted to co-operate; said co-operation adapted to vary in response to said signal analysis.

Preferably said plurality of co-operating generation means comprises a plurality of transceiving antenna.

Preferably said channel is reciprocal whereby optimal transmission antenna characteristics correspond with optimal receiving antenna characteristics; said receiving antenna characteristics optimised from signals received off said channel.

Preferably a second set of transceiving antenna located at a second end of said channel; said system adapted to optimise said second set of antenna by communicating optimal antenna characteristics of the first set of antenna.

Preferably said communication utilises a packet of data transmitted in a contention or access slot of a multiple access system.

Preferably said reciprocal channel utilises a time division duplexing scheme.

### BRIEF DESCRIPTION OF THE DRAWINGS

Reference will now be made to the accompanying drawings wherein:

FIG. 1 is a schematic representation of a scanning/selection combiner;

FIG. 2 shows a schematic representation of an equal gain combiner;

FIG. 3 shows a schematic representation of a maxiaml ratio combiner

FIG. 4 shows transmission antenna diversity

FIG. 5a shows optimisation of receive antenna

FIG. 5b shows optimisation of a transmit antenna

FIG. 5c shows signaling between first and second signal transcieving stations

FIG. 6 shows multiple transcieving stations with antenna diversity

### DESCRIPTION OF THE PREFERRED EMBODIMENTS

Performance of a telecommunications network can be measured from a number of perspectives. These include system capacity, data throughput rate, call blocking rate, voice quality and a number of other metrics. System operators may desire to vary these performance perameters depending on time of day, time of year or current use profiles. Such variation of system performance may be referred to as optimisation.

In radio communications systems optimisation may also be required to compensate for changes in channel conditions brought about due to varying atmospheric conditions and other changes in conditions and use profiles.

Diversity is often used within a radio communications system to improve system performance. The term “diversity” generally refers to the use of a plurality of techniques that perform similar functions. Receive antenna diversity is an example of such a system, where a number of antenna are employed to improve system performance.

Other types of diversity can be used, such as coding diversity, and frequency diversity. Each of these techniques can be used to change the characteristics of the generated signal, so that system performance can be optimised.

Antenna diversity for received signals is described in the applicants copending application U.S. Ser. No. 08/546,575. Aspects of this disclosure are now repeated below.

One method improving receive system gain and reducing the effect of fading is to include some form of diversity gain within a radio communications system. The object of a diverse antenna system is to provide the receiver with more than one path, with the paths being differentiated from each other by some means, e.g. space, angle, frequency or polarisation. The use of these additional paths by the receiver provides the diversity gain. The amount of gain achieved depends upon the type of diversity, number of paths, and method of combination.

There are three distinct methods of combining:

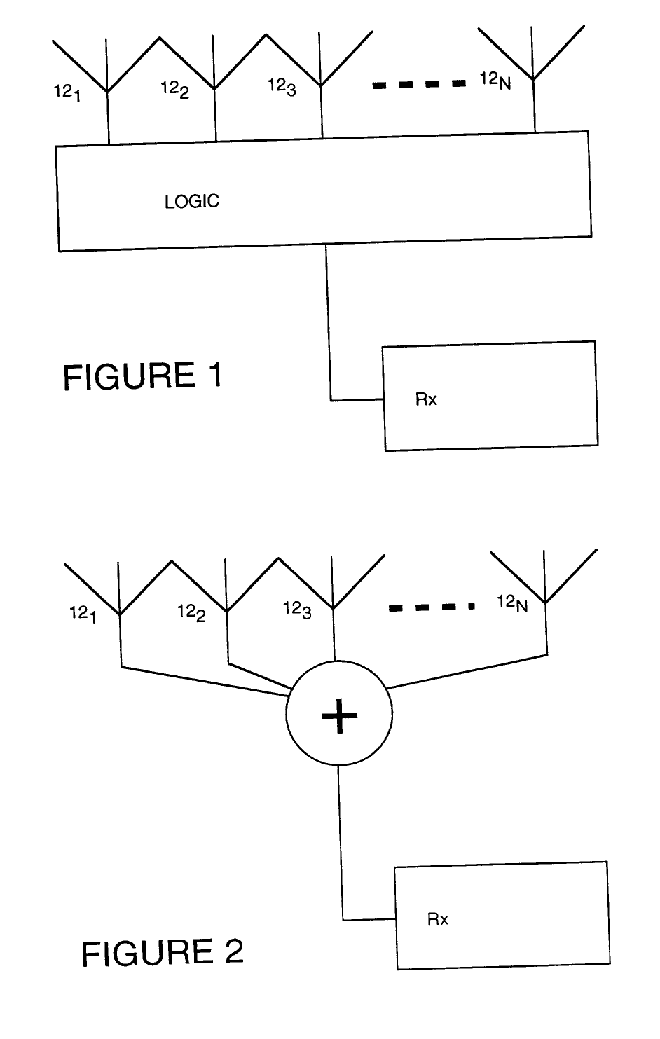

(i) Scanning and selection combiners (FIG. 1) wherein only one antenna of a number of antennas is employed and the outputs of the other antennas are discounted;

(ii) Equal gain combiners, (see FIG. 2) wherein the signals from all the antennas are summed and amplified by an equal extent; and

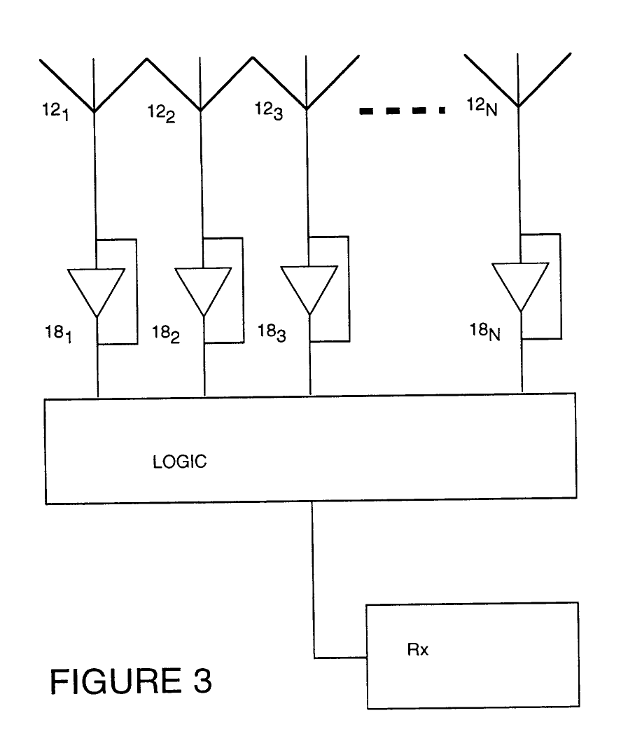

(iii) Maximal ratio combiners, (see FIG. 3) wherein each signal is weighted in proportion to its signal to noise ratio (SNR) before summation.

The simplest of the combination techniques is the basic switch diversity system having two antennas: each of the received paths is analysed and the best received signal is employed. If the signals are uncorrelated then when one is in a face, the other has a high probability of not being in a fade. Therefore in a BPSK system it can be possible to achieve up to 3 dB of diversity gain, at 5% BER, by selecting the best available output. Where a number of antennas are present, the method of choosing the particular antenna has the best signal-to-noise ratio (SNR); or (b) in scanning, the output signals from the antennas are sequentially tested and the first signal which is greater than a present threshold is selected as an acceptable signal—this signal is therefore not necessarily the best, but is employed until it drops below the threshold, when the scanning procedure is restarted.

With “co-phasal” or “equal gain diversity”, as its name implies the output is simply the sum of all inputs with equal weight irrespective of the input SNR.

Maximal ratio combining produces the best distribution curves of these diversity systems, but still uses multistage processors to calculate algorithms which adjust the weight of each path before combining all of the available paths. For a BPSK system using four branch optimal combining, it should be possible to achieve at least 6 dB of diversity gain without fading (simply due to the increased antenna aperture of 10 log 4) and in a Rayleigh fading environment with zero signal correlation and 5% BER, diversity gains up to 10 dB are available.

The improvements in SNR obtainable from the three techniques are (in order of best to worst): maximal ratio, co-phasal and basic switch diversity (or selection), but due to the complexity and cost of a maximal ratio combining arrangement, less complex combining schemes are often deployed.

One method of received antenna diversity switches the antenna which has the largest signal to noise ratio first with subsequent antenna switched through to the output, providing the following condition is satisfied:

CNR_{N+1}≧(²\sqrt{N+1}−\sqrt{N})²CNR_{N}

where N=number of channels in previous CNR calculation, and; CNR_{N}=prevoiusly calculated carrier-to-noise ratio.

The carrier-to-noise ratio in the algorithm could be replaced by the carrier-to-noise plus interference ratio (CNIR).

The present invention uses channels with “pseudo-reciprocal” or “semi-symmetrical” and “reciprocal” properties to implement transmission antenna diversity.

A reciprocal channel is one where the transmission path parameters and receive path parameters are identical. An example of such a channel is one using Time Division Duplex modulation/encoding. By using such a channel, transmission antenna optimisation is achieved by optimising the antenna for received signals and then using this optimisation for transmitting signals.

A “pseudo-reciprocal” or “semi-symetrical” channel is one where the transmission parameters of the channel can be determined from the received signal. Such a system will typically require processing of the received signal to determine the parameters of the receive channel. Further processing is then typically necessary to determine transmitting channel parameters. This situation often arises where separate transmitting and receiving antenna are used or where a different coding scheme is used on the transmit path to that used on the receive path.

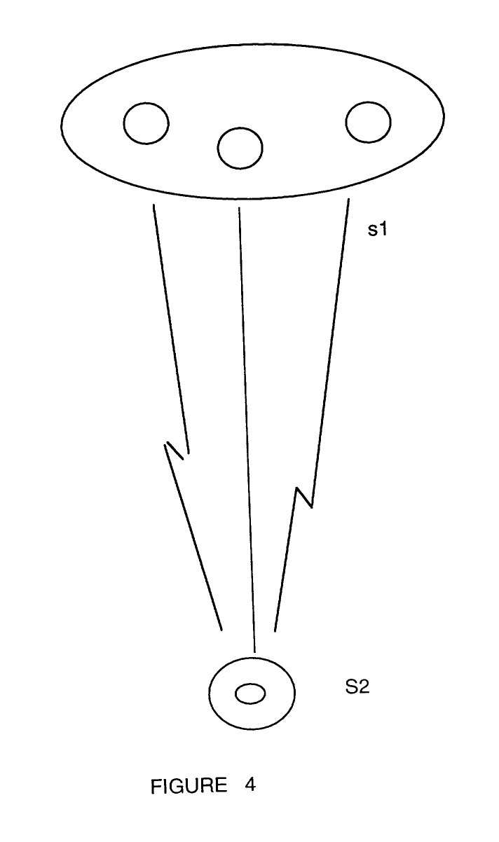

In FIG. 4, station 2 (S2) transmits to station 1 (S1). S1 employs antenna diversity. The signals received by S1 are analysed and the transmitting Antenna characteristics are optimised.

The characteristics of the transmit path from S1 to S2 are known, since the properties of the channel from S1 to S2 can be determined from an analysis of the signals transmitted from S1. Such a channel may be called a “pseudo-reciprocal” or “semi-symetrical” channel. When the characteristics of the channel from s1 to s2 have been determined, the transmit antennas can be optimised.

An alternative embodiment uses a channel with reciprocal characteristics, such as a time diversion duplex channel. In this embodiment, S1 receives the signal from S2 and optimises the receive antennas.

Relying on the reciprocal nature of the channel, allows the optimisation applied to the receiving antennas to be applied to the transmit antennas. Hence, by utilising a reciprocal channel, optimisation of the transmit antennas may be achieved by optimising the receive antennas.

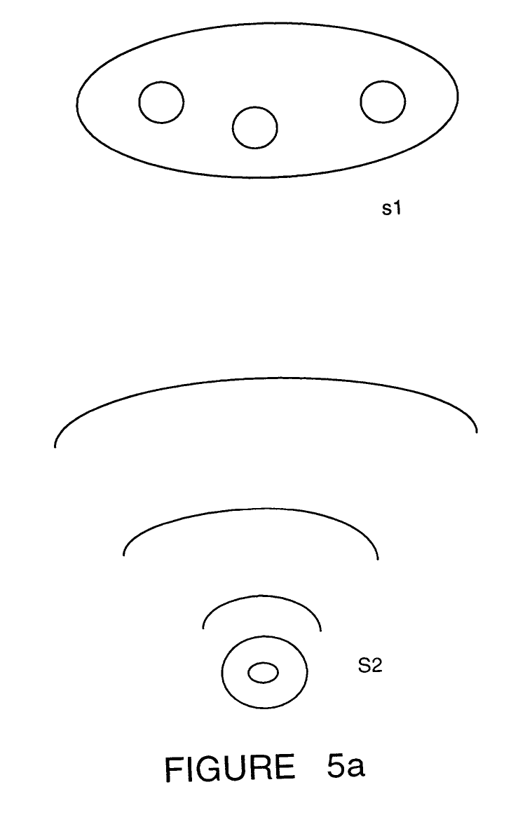

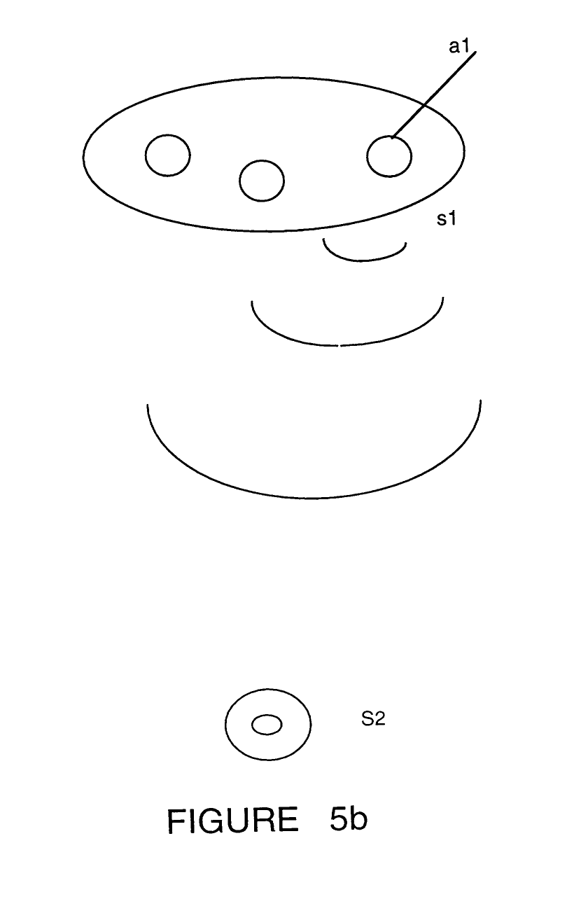

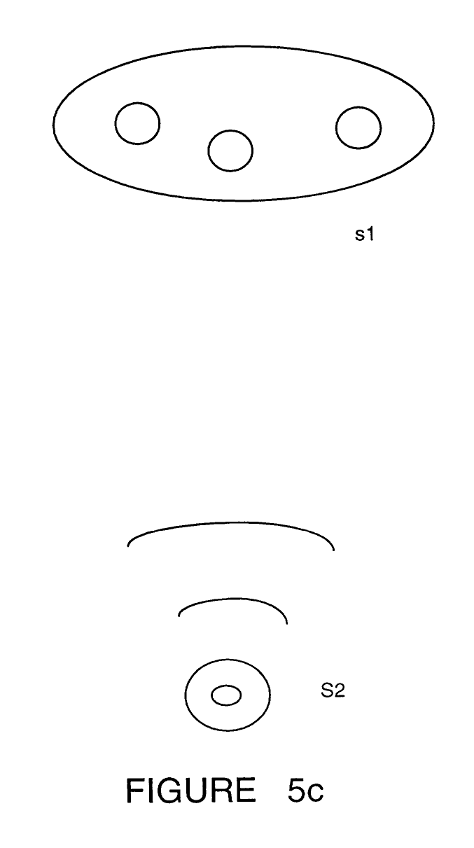

FIG. 5a represents an optimisation routine. During data transmission, especially extended duration data transmission such as video transmission or internet browsing, the channel between S1 and S2 may have faded, rendering receive characteristics of signals for S2 non-optimal. When this occurs, S2 signals S1 with a packet indicating the changes required, e.g. increase in power, vary signal encoding etc. S1 receives this signal from S2 and alters the signal characteristics accordingly In some embodiments, the signal from S2 to S1 indicating required changes to the transmitted signal is for S1 to optimise its transmitting antenna.

FIG. 5b is a representation of the above optimisation. Having received an optimisation request from S2 (this is depicted in FIG. 4), S1 has determined that transmission on antenna a1, alone is optimal. In FIG. 5c, S2 signals to S1 that the optimisation is sufficient. Should the optimisation not be sufficient, then S1 may conduct furtehr optimise routines to further optimise the system.

In an alternative embodiment, when S2 detects that the receive signal is non-optimal it commences a handshake protocol in order to optimise the transmit antenna of S1. Where the channel is reciprocal, the receive antenna of a S1 is optimised, then the transmit antenna of S1 is also optimised. Due to optimisation of the transmit antenna of S1, received signal characteristics at S2 are improved.

S1 may also analyse the channel from the signal transmitted from S2 and determine the changes to transmit signal parameters that are required. S1 may use standard signal processing techniques for this.

At call set up, one embodiment also uses a handshake approach to optimise transmit antenna characteristics. Referring now to FIG. 5a again, in this embodiment, S2 is initiating access to S1. During the call set up procedures, S1 optimises its transmit antenna based on the characteristics of the signal received from S2. Where a reciprocal channel is in use, S1 will proceed by optimising the receive antenna. As stated above, this will optimise the transmit antenna.

In FIG. 5b, S1 transmits a signal to S2. The signal is a proposal as to the parameters of the transmit signal. In FIG. 5c, S2 confirms the parameters or rejects the parameters. Where the parameters are confirmed transmission of information between S1 and S2 proceeds. Where the parameters are rejected, the process is repeated until a set of parameters are agreed upon.

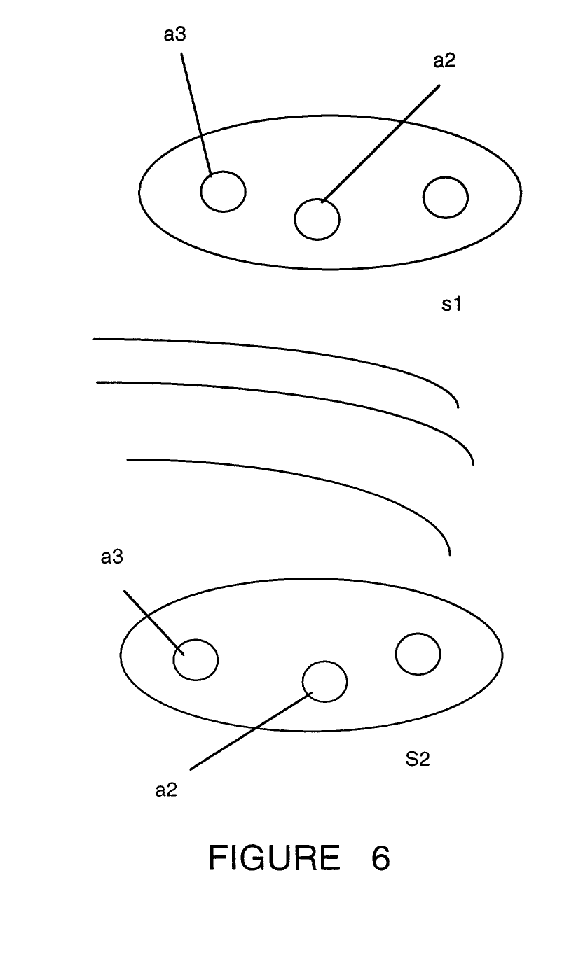

FIG. 6 depicts a system where both stations employ antenna diversity. In this system, S2 has been optimised by signals received from S1. S2 has decided on a combination of signals from antennas a2 and a3. When optimisation has been determined, S2 communicates these optimisation parameters to S1. S1 is then optimised according to these p[aramaters.

In an alternative embodiment, S1 will optimise itself from the signal received from S2. S1 will communicate with S2 whether or not it agrees with the optimisation suggested by S2. When there is not agreement, S2 will optimise its antenna from the signal received from S1. S2 will then communicate its agreement or disagreement with the suggested optimisation. This process is repeated until the optimisation parameters for each station are within acceptable limits of each other.

In an embodiment utilising multiple access techniques such as TDMA, CDMA etc, it is preferable that a packet of information/instructions be transmitted when the stations communicate. As this embodiment typically requires optimising/adaptive data to be transmitted on a discontinuous basis it is not essential that a slot be reserved on every frame. The data packet can utilise a contention slot or an access slot. Alternatively, an available voice or data slot could also be used. Communication between the stations on this basis reduces system overhead as it improves efficiency in signaling overhead.

In an alternative embodiment, one or more slots are reserved in system overhead every frame for adaptive signalling. However the number of slots reserved is less than the total number of calls that the system supports at full capacity. In this arrangement, stations request access to these adaptive signalling slots. Access is allocated by the system according to system optimisation priorities. In this arrangement, a trade off between congestion on contention and access slots and increases in system overhead is achieved, according to system design parameters.

1. A radio communications system operating over a channel having characteristics such that parameters of a transmission path can be predicted from received signals; said system comprising means for analysing signals received from said channel and a plurality of signal generation means adapted to vary output in response to said signal analysis.

2. A radio communications system as claimed in claim 1 wherein said plurality of signal generation means are adapted to co-operate; said co-operation adapted to vary in response to said signal analysis.

3. A radio communications system as claimed in claim 1 wherein said plurality of signal generation means are adapted to co-operate; said co-operation adapted to vary in response to said signal analysis and wherein said plurality of co-operating generation means comprises a plurality of transceiving antenna.

4. A radio communications system as claimed in claim 1 wherein said plurality of signal generation means are adapted to co-operate; said co-operation adapted to vary in response to said signal analysis and wherein said channel is reciprocal whereby optimal transmission antenna characteristics correspond with optimal receiving antenna characteristics; said receiving antenna characteristics optimised from signals received off said channel.

5. A radio communications system as claimed in claim 1 wherein said plurality of signal generation means are adapted to co-operate; said co-operation adapted to vary in response to said signal analysis, wherein said plurality of co-operating generation means comprises a plurality of transceiving antenna and wherein said channel is reciprocal whereby optimal transmission antenna characteristics correspond with optimal receiving antenna characteristics; said receiving antenna characteristics optimised from signals received off said channel.

6. A radio communications system as claimed in claim 1 further comprising a second set of transceiving antenna located at a second end of said channel;
wherein said plurality of signal generation means are adapted to cooperate, said co-operation adapted to vary in response to said signal analysis; and
wherein said channel is reciprocal whereby optimal transmission antenna characteristics correspond with optimal receiving antenna characteristics;
said receiving antenna characteristics optimised from signals received off said channel;
said system adapted to optimise said second set of antenna by communicating optimal antenna characteristics of the first set of antenna.

7. A radio communications system as claimed in claim 1 further comprising a second set of transceiving antenna located at a second end of said channel;
wherein said plurality of signal generation means are adapted to cooperate, said co-operation adapted to vary in response to said signal analysis;
wherein said plurality of co-operating generation means comprises a plurality of transceiving antenna; and,
wherein said channel is reciprocal;
whereby optimal transmission antenna characteristics correspond with optimal receiving antenna characteristics;
said receiving antenna characteristics optimised from signals received off said channel said system adapted to optimise said second set of antenna by communicating optimal antenna characteristics of the first set of antenna.

8. A radio communications system as claimed in claim 1 further comprising a second set of transceiving antenna located at a second end of said channel;
wherein said plurality of signal generation means are adapted to cooperate, said co-operation adapted to vary in response to said signal analysis;
wherein said plurality of co-operating generation means comprises a plurality of transceiving antenna;
wherein said channel is reciprocal; and,
whereby optimal transmission antenna characteristics correspond with optimal receiving antenna characteristics;
wherein said communication utilises a packet of data transmitted in a contention or access slot of a multiple access system;
said receiving antenna characteristics optimised from signals received off said channel said system adapted to optimise said second set of antenna by communicating optimal antenna characteristics of the first set of antenna wherein said communication utilises a packet of data transmitted in a contention or access slot of a multiple access system.

9. A radio communications system as claimed in claim 1 wherein said plurality of signal generation means are adapted to co-operate; said co-operation adapted to vary in response to said signal analysis and wherein said channel is reciprocal whereby optimal transmission antenna characteristics correspond with optimal receiving antenna characteristics; said receiving antenna characteristics optimised from signals received off said channel, and wherein said reciprocal channel utilises a time division duplexing scheme.

10. A radio communications system as claimed in claim 1 wherein said plurality of signal generation means are adapted to co-operate; said co-operation adapted to vary in response to said signal analysis, wherein said plurality of co-operating generation means comprises a plurality of transceiving antenna and wherein said channel is reciprocal whereby optimal transmission antenna characteristics correspond with optimal receiving antenna characteristics; said receiving antenna characteristics optimised from signals received off said channel, and wherein said reciprocal channel utilises a time division duplexing scheme.

11. A radio communications system as claimed in claim 1 further comprising a second set of transceiving antenna located at a second end of said channel;
wherein said plurality of signal generation means are adapted to cooperate, said co-operation adapted to vary in response to said signal analysis; and
wherein said channel is reciprocal whereby optimal transmission antenna characteristics correspond with optimal receiving antenna characteristics;
said receiving antenna characteristics optimised from signals received off said channel;
said system adapted to optimise said second set of antenna by communicating optimal antenna characteristics of the first set of antenna, and wherein said reciprocal channel utilises a time division duplexing scheme.

12. A method of communicating over a channel having characteristics such that transmission path characteristics are predictable from signals received off said channel; said method comprising the steps of:
1) analysing signals received from said channel;
2) varying the output from a plurality of signal generation means in response to said signal analysis.

13. A method of communicating over a channel having characteristics such that transmission path characteristics are predictable from signals received off said channel; said method comprising the steps of:
1) analysing signals received from said channel;
2) varying the output from a plurality of signal generation means in response to said signal analysis, wherein said plurality of signal generation means are further adapted to co-operate; step 2) further comprising varying co-operation between said signal generation means in response to said signal analysis.

14. A method of communicating over a channel having characteristics such that transmission path characteristics are predictable from signals received off said channel; said method comprising the steps of:
1) analysing signals received from said channel;
2) varying the output from a plurality of signal generation means in response to said signal analysis, wherein said plurality of signal generation means are further adapted to co-operate; step 2) further comprising varying co-operation between said signal generation means in response to said signal analysis wherein said channel is reciprocal and said plurality of co-operating signal generation means comprise a plurality of transceiving antenna, varying receive antenna characteristics in response to said signal analysis and varying transmitting antenna characteristics corresponding to said variation in receive antenna characteristics.

15. A method as claimed in claim 12 wherein step 1) further comprises a time division multiplexing signal generation scheme.

16. A signal transmitting and receiving station for use with a radio communications system operating over a channel with characteristics such that parameters of a transmission path can be predicted from received signals; said station further comprising a plurality of signal receiving and signal processing means adapted to analyse signals received from said channel and a plurality of signal generation means adapted to vary output in response to said signal analysis.

17. A signal transmitting and receiving station for use with a radio communications system operating over a channel with characteristics such that parameters of a transmission path can be predicted from received signals; said station further comprising a plurality of signal receiving and signal processing means adapted to analyse signals received from said channel and a plurality of signal generation means adapted to vary output in response to said signal analysis wherein said plurality of signal generation means are further adapted to co-operate; said co-operation adapted to vary in response to said signal analysis.

18. A signal transmitting and receiving station for use with a radio communications system operating over a channel with characteristics such that parameters of a transmission path can be predicted from received signals; said station further comprising a plurality of signal receiving and signal processing means adapted to analyse signals received from said channel and a plurality of signal generation means adapted to vary output in response to said signal analysis wherein said plurality of signal generation means are further adapted to co-operate; said co-operation adapted to vary in response to said signal analysis, and wherein said plurality of co-operating signal generation means comprise a plurality of transceiving antenna.

19. A signal transmitting and receiving station for use with a radio communications system operating over a reciprocal channel with characteristics such that parameters of a transmission path can be predicted from received signals;
said station further comprising a plurality of signal receiving and signal processing means adapted to analyse signals received from said channel and a plurality of signal generation means adapted to vary output in response to said signal analysis;
wherein said plurality of signal generation means are further adapted to co-operate in response to said signal analysis;
wherein said plurality of co-operating signal generation means comprise a plurality of transceiving antenna; and
wherein said station adapted to vary receive antenna characteristics in response to said signal analysis and to vary transmit antenna characteristics corresponding to said variation in receive antenna characteristics.
